(19) United States
(12) Patent Application Publication
(10) Pub. No.: US 2005/0017859 A1
(43) Pub. Date: Jan. 27, 2005

(54) Object discriminating system for vehicles

(76) Inventors: Juergen Dickmann, Ulm (DE); Moheb Mekhaiel, Neu-Ulm (DE)

Correspondence Address: PENDORF & CUTLIFF, 5111 Memorial Highway, Tampa, FL, 33634-7356, US

(21) Appl. No.: 10/852,062

(22) Filed: May 24, 2004

(30) Foreign Application Priority Data
May 22, 2003 (DE) 103 23 707.0

(51) Int. Cl. B60Q 1/00

(52) U.S. Cl. 340/435

(57) ABSTRACT

The invention concerns an object recognition system for vehicles, which is particularly suited, for identifying unprotected traffic participants such as for example bicyclists or pedestrians. For this a combination (1) of thermopiles (2) is proposed, of which the detection realm or range cover the essential ahead of or as the case may be behind the vehicle. By detection of the thermal radiation emitted by objects an analysis of the detected signals in an evaluation unit (5) the system is capable of discriminating persons from other objects. In combination with driving parameters such as for example speed and steering wheel angle, the system can recognize in timely manner an imminent collision with a pedestrian or bicyclist and initiate appropriate measures.

### BACKGROUND OF THE INVENTION

1. Field of Invention

The invention concerns a system for recognizing objects. Systems of this type are important particularly in motor vehicles, in order to be able, in traffic, to recognize as early as possible a critical approach to obstacles, other vehicles and, in particular, unprotected traffic participants (pedestrians, bicyclists, etc.). For this, a recognition system must be able to detect relevant objects rapidly and at the same time be able to distinguish persons from other objects.

2. Related Art of the Invention

Known systems for object recognition include, for example, equipment involving ultrasound or infrared radiation. Ultrasound signals or infrared light is emitted via an emitter from the vehicle into the environmental area of interest and the signal components reflected from objects are recorded via one or more receivers. The received signals are then analyzed in order to determine the position and/or distance of objects (for example, by time differential, intensity, phase).

A disadvantage with such systems is that the transmission of the signal through the air is subject to weather conditions (fog, rain, dust) with various sources of interference which complicate evaluation and, in the case of object recognition, can lead to false results. Further, the various types of objects can only be discriminated very generally, for example with regard to height, or not at all.

In EP 0546928 B1 an evaluation device for vehicles is proposed for discrimination of and improved identification of obstacles, which device combines two different types of sensors. For the spatial detection of objects pulses (microseconds) of infrared light are emitted via one or more rows of light emitting diodes with various angles of emission, and the infrared light components reflected by obstacles are recorded using a matrix of photodiodes. Evaluation thereof results in an initial image or map of the spatial distribution of objects present, for example, in the area ahead of the vehicle. For the further differentiation of objects from each other, a pyro-electric detector integrated in the device is used for detection of thermal radiation emitted by the objects themselves. It is the goal of this system to evaluate the various signal components via a computer and thereby to identify vehicles on the basis of the heat they develop relative to other obstacles.

This system has the disadvantage that, as a result of the use of the different emitter and receiver devices, a relatively high technical complexity is unavoidable, and this is associated with a corresponding susceptibility to defect. Thus, on the one hand, the spatial object detection using IR-pulses can be interfered with by, for example, strong rain, snow, dust, blowing leaves, and/or the thermal probes can be rendered useless due to thermal sources such as a strongly heated road surface in summer or when driving in the direction of the sun when it is low on the horizon.

A reliable identification of, in particular, the endangered unprotected traffic participants such as bicyclists or pedestrians has not been taken into consideration by this system and it is not suited therefore since persons—in comparison to vehicles—emit only a relatively weak body thermal signature. Besides this, the pyro-electric detectors employed here react only incrementally to relatively abruptly occurring differences in thermal radiation emitted by objects, that is, the absolute values are not detected. Multiple different thermal sources (vehicle emissions, motorcycle exhaust, pedestrian) in the “field of view” of the detector are thus qualitatively not discriminated or distinguished.

### SUMMARY OF THE INVENTION

The present invention begins with such a system as the closest state of the art. It is the task of the present invention to develop an alternative object recognition system for employment in vehicles, that is suited in particular for identifying unprotected traffic participants such as pedestrians, etc.

This task is solved by a vehicle-based system for identification of objects in traffic, in particular persons, including sensors (2) that react to sources of thermal energy, means (3) for amplification as well as means (5) for evaluation of the signals supplied by the sensors, wherein the sensors are thermopiles. Further details and advantages embodiments of the invention are set forth below.

### BRIEF DESCRIPTION OF THE DRAWING

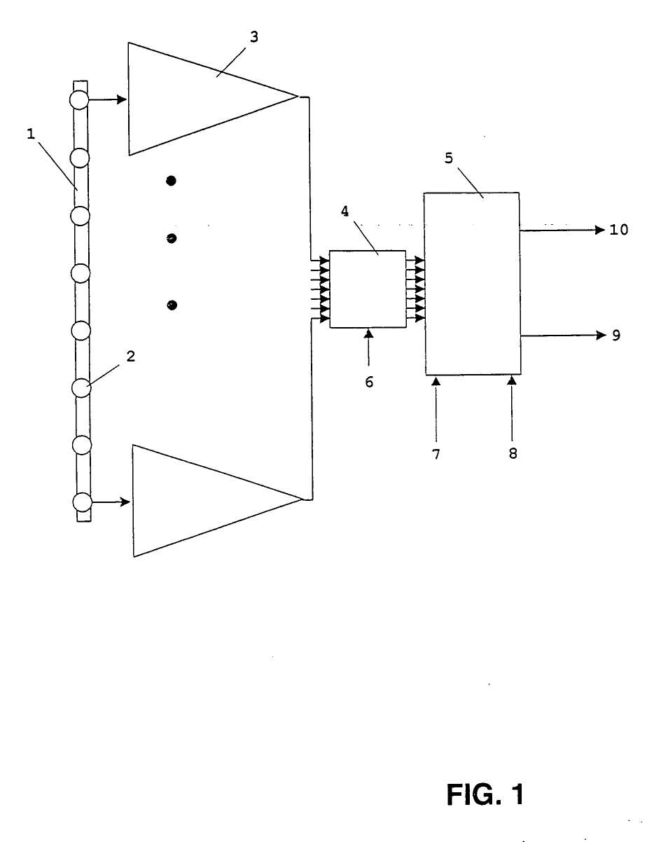

The invention is described in greater detail in the following. In FIG. 1 an illustrative embodiment of the invention is shown.

### DETAILED DESCRIPTION OF THE INVENTION

The invention takes advantage of the fact that all objects emit electromagnetic waves. The respective frequency range is basically dependent upon the temperature of the object. The warmer the object, the higher the emitted energy. The spectral maximum of the emission of a pedestrian at approximately 37° C. body temperature lies for example at a wavelength of approximately 10 micrometer.

Since the body temperature of a human remains relatively constant within a narrow range, it is possible, by means of suitable wavelength sensitive sensors, to discriminate a bicyclist or pedestrian in road traffic from other objects, to the extent that the temperatures of other object are lower or higher. As sensors for the IR-detection in the range of between 8 and 14 μm, thermopile-detectors are excellent. They can be operated in this application without means for cooling, they have a good transient or transient oscillation behavior and they are commercially relatively inexpensive. In comparison to pyro-detectors, thermopile detectors can detect both dynamic as well as static objects. Therewith they distinguish themselves from pyro-detectors, which are employed for example in PIR (passive infrared) motion detectors and can only react to temperature changes.

The somewhat lower sensitivity in comparison to pyro-detectors limits the maximal detectable distance for thermopiles. This disadvantage can however be compensated with suitable lenses or optics. Thus, for example, by reduction of the detection angle (field of view, FOV) to a 10° aperture angle or less, the sensitivity can be accommodated, such that a pedestrian can be reliably detected at distances of up to 10 meter. Such optical supplements can either be positioned upstream as a separate add on (lens, mirror) or already be integrated in the thermopile housing (for example the detector TPS334L10.6 of Perkin-Elmer Optoelectronics or ST60 from Dexter Research).

In order to increase the local sensitivity or, as the case may be, the spatial detection range of the inventive object discrimination system, multiple thermopiles can be interconnected. For example, a number of thermopiles can be arranged linearly as a line in a row, so that the detection ranges overlap in a plane. Further, multiple of such lines of thermopiles can be combined and thus, for example, two dimensional arrays can also be constructed. Therewith any desired form of detection range can be constructed.

Arrays of thermopiles are commercially available—including already integrated upon one chip. In such combinations the thermopiles are conventionally arranged equal-distant, other arrangements with different distances of the detectors can be more advantageous for certain conditions of employment (for example, for higher sensitivity and localized resolution in the frontal area of the vehicle).

In FIG. 1 a linear configuration 1 of eight thermopiles 2 is shown as an illustrative embodiment. Therein the arrangement is so selected, that the optical detection area of the adjacent detectors overlap. The individual signals of the thermopiles are processed via amplifier stages 3. These amplifier stages are preferably so arranged, that it is also possible to have a first electronic filtering of the signals of interference components (suppression of white noise, temperature compensation, etc.).

In this illustrative embodiment, downstream of the amplifiers are means 4 for further signal processing. Here—for example by comparison with supplied reference values 6—a measurement signal correction takes place. For this, reference values can be supplied for example by one or more separate reference thermopiles (not shown), or which may exist as values in memory.

The thus prepared signals are supplied to an evaluation unit 5. In this evaluation unit the individual signal components are analyzed respectively based on the various thermopiles for predetermined criteria, for example, determining maximum, dynamic changes, exceeding or falling below threshold values, determining intensity via the sensor line, and changes in these intensity values over time, etc.

Using the signal processor, different thermal sources (persons, motor vehicles, motorcycle exhaust) can be discriminated and, for example, size, position and distance of the objects detected by the thermopiles can be determined.

Elements of the signal evaluation unit 5 can be in the form of, for example, a microprocessor system. This also provides the possibility of object classification by comparison of the actual signal components with data in memory. Thus, for example, a pedestrian can be identified rapidly and reliably on the basis of characteristic signal constellations and/or signal changes.

In a further embodiment, the evaluation unit 5 is additionally provided with signals regarding the operating parameters of the motor vehicle. In FIG. 1 this is represented by the input ports 7 and 8. As parameters there can be taken into consideration in the signal processing, for example, the actual vehicle speed, steering wheel angle or brake deceleration value. This leads thereto that the system takes into consideration vehicle-specific dynamic changes of the signals provided by the thermopiles, and thus the system exhibits a reduced error rate. Further, the size or distance of an object can be estimated by taking into consideration the own vehicle movement.

The precision of recognition can be further increased when, in addition to the thermopiles, other sensors for detecting the environment are present, such as for example near range radar, ultrasound or a laser scanner, and their signals are taken into consideration in the evaluation.

As shown in FIG. 1 the system exhibits an output port 9, 10, via which object information, warning signals or control signals are relayed or transmitted. Thus for example the detected objects can be displayed to the vehicle operator with appropriate identification symbols via an optical masking or overlay on the display, and in the case of critical proximity and speed it is possible for optical or acoustic warning signals to be triggered, or in certain cases, where there is danger of collision, a direct intervention in the vehicle operation (for example activation of brakes) can be initiated.

The array proposed in this illustrative embodiment is comprised of a line of equidistant arranged individual sensors, which can be positioned at a suitable location on the vehicle, such as for example the bumper. Since the application of such a row of detectors is not possible in all cases for every vehicle, the actual arrangement can be optimized taking into consideration the possible integration sites available on the vehicle. The vertical as well as the horizontal tilt angle of the module can be varied taking into consideration the geometric existing situation.

1-13. (Cancelled)

14. The system according to claim 11, including means (4) for signal correction, involving comparison with reference values.

15. The system according to claim 11, wherein the means (5) for evaluation of the sensor signals includes a microprocessor.

16. The system according to claim 11, wherein the means (5) for evaluation of the sensor signals include elements for recording data.

17. The system according to claim 11, wherein the means (5) for evaluation of the sensor signals include one or more entry ports (7,8), via which supplemental signals regarding operating parameters are taken into consideration for evaluation.

18. The system according to claim 17, wherein said supplemental signals regarding operating parameters is at least one of vehicle speed, steering wheel movement and braking deceleration.

19. The system according to claim 11, wherein the means (5) for evaluation of the sensor signals include one or more outlet ports (9, 10), via which signals are emitted following recognition of objects.

20. The system according to claim 19, wherein said signals are emitted to indicator elements or displays.

21. The system according to claim 19, wherein the means (5) for evaluation of the sensor signals emit warning signals via output ports (9, 10) in the case of recognition of the dangerous approaching of the own vehicle to a recognized object.

22. The system according to claim 19, wherein the means (5) for evaluation of the sensor signals emit, in the case of recognition of the dangerous approaching of the own vehicle to a recognized object, signals via the outlet ports (9, 10), which signals control components of the vehicle control.

23. The system according to claim 22, wherein said component of the vehicle control is the brake system.

24. A vehicle-based system for identification of humans in traffic, comprising
sensors (2) which react to sources of thermal energy,
means (3) for amplification of the signals supplied by the sensors,
means (5) for evaluation of the signals supplied by the sensors,
wherein the sensors are thermopiles.

25. The vehicle-based system as in claim 24, wherein said thermopiles are adapted to discriminate the thermal signature of a bicyclist or pedestrian in road traffic from other objects, to the extent that the temperatures of other object are lower or higher.

26. The vehicle-based system as in claim 24, wherein said thermopiles are sensitive to infrared wavelengths in the range of between 8 and 14 μm.
